(19) United States
(12) Patent Application Publication
(10) Pub. No.: US 2026/0093200 A1
(43) Pub. Date: Apr. 2, 2026

(54) SHEET THICKNESS DETECTOR, SHEET CONVEYOR, AND IMAGE FORMING APPARATUS

(71) Applicants: Kazuya TONOMURA, Tokyo (JP); Kazuki HABA, Tokyo (JP); Kohtaroh ODA, Kanagawa (JP)

(72) Inventors: Kazuya TONOMURA, Tokyo (JP); Kazuki HABA, Tokyo (JP); Kohtaroh ODA, Kanagawa (JP)

(73) Assignee: Ricoh Company, Ltd., Tokyo (JP)

(21) Appl. No.: 19/309,035

(22) Filed: Aug. 25, 2025

(30) Foreign Application Priority Data
Sep. 30, 2024 (JP) 2024-171782

(51) Int. Cl. G03G 15/00; G03G 15/01

(52) U.S. Cl. CPC G03G 15/6594; G03G 15/0189; G03G 15/6514; G03G 15/6529; G03G 2215/00392; G03G 2215/00679; G03G 2215/00738

(57) ABSTRACT

A sheet thickness detector includes a conveyance roller pair, a pressing member, a separation mechanism, and a displacement detector. The conveyance roller pair includes a conveyance roller rotatable about a drive shaft to convey a sheet in a sheet conveyance direction, and a detection roller separately contactable with the conveyance roller to nip the sheet at an initial position. The pressing member presses the detection roller to the conveyance roller in a contact direction. The separation mechanism separates the detection roller from the conveyance roller in a separation direction. The displacement detector detects a displacement of the detection roller in the separation direction from the initial position to detect a thickness of the sheet in response to a nip of the sheet by the conveyance roller pair. The separation mechanism is decoupled from the detection roller in response to a detection of the thickness of the sheet.

### CROSS-REFERENCE TO RELATED APPLICATION

This patent application is based on and claims priority pursuant to 35 U.S.C. § 119(a) to Japanese Patent Application No. 2024-171782, filed on Sep. 30, 2024, in the Japan Patent Office, the entire disclosure of which is hereby incorporated by reference herein.

### BACKGROUND

### Technical Field

Embodiments of the present disclosure relate to a sheet thickness detector, a sheet conveyor, and an image forming apparatus.

### Related Art

There has been known a typical sheet thickness detector including: a conveyance roller pair including a conveyance roller that conveys a sheet and a detection roller supported so as to be contactable with and separable from the conveyance roller in a contact-separation direction orthogonal to both a sheet conveyance direction and a rotation shaft direction of the conveyance roller; a pressure unit that pressurizes the detection roller toward the conveyance roller; a separation mechanism that separates the detection roller from the conveyance roller; and a displacement detection unit that detects displacement of the detection roller in the contact-separation direction from an initial position in a state where the detection roller is in contact with the conveyance roller.

The sheet thickness detection is performed based on the displacement of the detection roller detected by the displacement detection unit when the sheet is nipped by the conveyance roller pair.

A sheet thickness detector in the art that positions a detection roller at a separation position separated from a conveyance roller by a separation mechanism until the leading end of a passbook as a sheet enters the conveyance roller. When the leading end of the passbook enters the conveyance roller, the detection roller is moved from the separation position toward a contact position, which is the initial position at which the detection roller contacts the conveyance roller, by the separation mechanism to bring the detection roller into contact with the passbook, and the passbook is nipped and conveyed by the conveyance roller and the detection roller. It is described that the resistance force when the passbook enters the conveyance roller does not act on the passbook by positioning the detection roller at the separation position when the leading end of the passbook enters the conveyance roller. Then, when the passbook is nipped between the conveyance roller and the detection roller, displacement of the detection roller is detected by a sensor as a displacement detection unit to detect the thickness of the passbook.

In the sheet thickness detector in the art, the separation mechanism includes a solenoid, an arm member, and a torsion spring as a pressure unit. The solenoid is coupled to one end of the arm member, and a coil portion of the torsion spring is attached to the other end. One end portion of the torsion spring has a hook shape, and is attached to a shaft of the detection roller. The other end of the torsion spring is attached to the arm member so that the detection roller is biased toward the conveyance roller. When one end of the arm member is pushed in the contact-separation direction toward the conveyance roller by the solenoid, the arm member rotates, and the other end of the arm member moves in a direction away from the conveyance roller. As a result, the torsion spring as the pressure unit attached to the other end of the arm member moves in the direction away from the conveyance roller, and the detection roller moves in the direction away from the conveyance roller. When the detection roller is moved from the position separated from the conveyance roller toward the contact position, one end of the arm member is moved in the direction away from the conveyance roller by the solenoid, and the arm member is rotated in a direction opposite to the above direction, so that the torsion spring is moved toward the conveyance roller together with the other end of the arm member. As a result, the detection roller moves toward the initial position at which the detection roller contacts the conveyance roller.

However, there is a possibility that accurate thickness detection cannot be performed.

### SUMMARY

Embodiments of the present disclosure described herein provide a novel sheet thickness detector including a conveyance roller pair, a pressing member, a separation mechanism, and a displacement detector. The conveyance roller pair includes a conveyance roller and a detection roller. The conveyance roller is rotatable about a drive shaft to convey a sheet in a sheet conveyance direction. The detection roller is separately contactable with the conveyance roller to nip the sheet between the conveyance roller and the detection roller at an initial position. The pressing member presses the detection roller to the conveyance roller in a contact direction orthogonal to the sheet conveyance direction and an axial direction of the drive shaft. The separation mechanism separates the detection roller from the conveyance roller in a separation direction opposite to the contact direction. The displacement detector detects a displacement of the detection roller in the separation direction from the initial position to detect a thickness of the sheet in response to a nip of the sheet by the conveyance roller pair. The separation mechanism is decoupled from the detection roller in response to a detection of the thickness of the sheet.

Further, embodiments of the present disclosure described herein provide a sheet conveyor including the above-described sheet thickness detector to detect the thickness of the sheet.

Further, embodiments of the present disclosure described herein provide an image forming apparatus including the above-described sheet thickness detector.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view illustrating a schematic configuration of an image forming apparatus according to an embodiment of the present disclosure;

FIG. 2 is a perspective view illustrating a schematic configuration of a sheet thickness detector according to the present embodiment;

FIG. 3 is a schematic cross-sectional view of a conveyance roller pair included in the sheet thickness detector;

FIG. 4 is a schematic view illustrating a relationship between a pressure arm and a fixed shaft of the sheet thickness detector;

FIG. 5 is a schematic perspective view of a separation mechanism included in the sheet thickness detector;

FIG. 6 is a block diagram of the sheet thickness detector;

FIG. 7A is a control flowchart of a separation operation;

FIG. 7B is a control flowchart of a contact operation; and

FIG. 8 is a schematic view illustrating a relationship between a contact-separation arm and the fixed shaft.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A description is provided of an electrophotographic image forming apparatus according to an embodiment of the present disclosure.

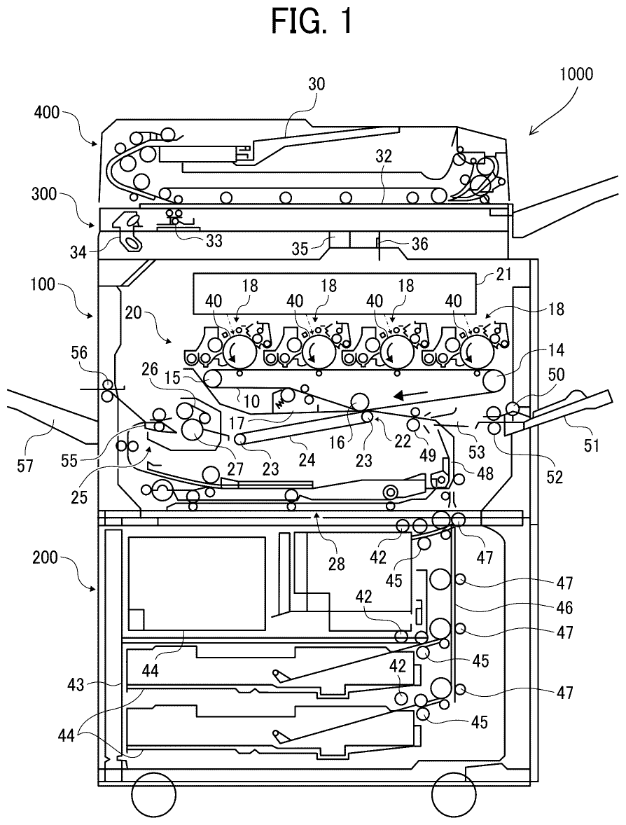

FIG. 1 is a schematic view illustrating a schematic configuration of an image forming apparatus 1000 according to an embodiment of the present disclosure.

As illustrated in FIG. 1, the image forming apparatus 1000 according to the present embodiment includes a toner image former 20 including four image formation devices that form toner images of respective colors of yellow (Y), cyan (C), magenta (M), and black (K). Each of the image formation devices includes a photoconductor unit 40 as a latent image bearer, a charger unit 18 as a charger, a developing unit as a developer, a cleaning unit as a cleaner, and the like. Each of the image formation devices includes an integrated circuit (IC) tag and is detachably attached to the main body of the image forming apparatus 1000.

Above the toner image former 20, a writing unit 21 that forms an electrostatic latent image by irradiating the surface of a photoconductor drum in the photoconductor unit 40 of each image formation device with laser light according to image information is provided. Below the toner image former 20, an intermediate transfer unit is provided, and the intermediate transfer unit is provided with an intermediate transfer belt 10, which is an endless belt. The intermediate transfer belt 10 may be, for example, a multilayer belt in which an elastic layer is provided on a base layer made of a material that is difficult to stretch, such as a fluororesin having a small stretch, or a rubber material having a large stretch and a canvas. As the elastic layer, for example, a layer obtained by coating a surface of a fluorine-based rubber or an acrylonitrile-butadiene copolymer rubber with, for example, a fluorine-based resin to form a coating layer having excellent smoothness can be adopted.

The intermediate transfer belt 10 is stretched around three support rollers, which are a first support roller 14, a second support roller 15, and a third support roller 16, and is driven to rotate clockwise in FIG. 1. An intermediate transfer body cleaning unit 17 for removing unnecessary toner on the intermediate transfer belt 10 is disposed on the right side of the second support roller 15 in FIG. 1. A secondary transfer unit 22 is disposed below the intermediate transfer belt 10. The secondary transfer unit 22 has a configuration in which a secondary transfer belt 24 which is an endless belt is stretched between two secondary transfer counter rollers 23, and biases the secondary transfer belt 24 to be pressed against the third support roller (secondary transfer roller) 16 that supports the intermediate transfer belt 10. The secondary transfer belt 24 performs a transfer process for secondarily transferring, onto a sheet, a toner image primarily transferred onto the intermediate transfer belt 10.

On the left side of the secondary transfer unit 22 in the drawing, a fixing unit 25 that fixes the toner image secondarily transferred onto a sheet (paper) to the sheet is provided. The fixing unit 25 has a configuration in which a pressure roller 27 is pressed against a fixing belt 26 which is an endless belt. Below the secondary transfer unit 22 and the fixing unit 25, a sheet reversing unit 28 that reverses the front and back of the sheet on which the toner image has been fixed and feeds the sheet to record the toner image on the back surface of the sheet is provided.

When a start switch of an operation unit is pressed, a document on a document feeding table 30 of an automatic document feeder (ADF) 400 is conveyed onto a contact glass 32. When a document is not present in the ADF 400, a scanner of an image reading unit 300 is driven to read a document placed by hand on the contact glass 32, and a first carriage 33 and a second carriage 34 are driven for reading and scanning. Light is emitted from a light source on the first carriage 33 to the contact glass. Reflected light from a surface of the document is reflected by a first mirror on the first carriage 33 toward the second carriage 34. The reflected light reflected by a mirror on the second carriage 34 forms an image on a reading sensor 36 including a charge coupled device (CCD) through an imaging forming lens 35. Color recording data of K, Y, M, and C is generated based on an image signal obtained by the reading sensor 36.

In addition, when the start switch is pressed, the rotational driving of the intermediate transfer belt 10 is started, image formation preparation of each unit in each image formation device is started, and an image formation sequence of each color is executed. Then, the writing unit 21 irradiates the photoconductor drums of respective colors with exposure laser modulated based on the color recording data, and toner images in the respective colors are superimposed and transferred as one image on the intermediate transfer belt 10 by image formation processes of the respective colors. In this way, the sheet is fed into a secondary transfer area in accordance with the timing at which the leading end of the toner image on the intermediate transfer belt 10 enters the secondary transfer area facing the secondary transfer unit 22. As a result, the toner image on the intermediate transfer belt 10 is secondarily transferred onto the sheet. The sheet to which the toner image has been transferred is fed into the fixing unit 25, where the toner image is fixed to the sheet.

The sheet subjected to the fixing process by the fixing unit 25 and discharged is guided to an ejection roller 56 by a switching claw 55 and stacked on a sheet ejection tray 57. Alternatively, the sheet is guided to the sheet reversing unit 28 by the switching claw 55, reversed and guided again to the secondary transfer area, an image is also recorded on the back surface, and then the sheet is ejected onto the sheet ejection tray 57 by the ejection roller 56. On the other hand, the residual toner remaining on the intermediate transfer belt 10 after the secondary transfer is removed by the intermediate transfer body cleaning unit 17 to prepare for the subsequent image forming.

The sheet described above is fed from one of sheet trays 44 provided in multiple stages in a sheet feeding unit 43 by selectively rotationally driving one of sheet feed rollers 42 of a sheet feeding table 200. Then, only one sheet is separated by a separation roller 45, placed in a conveyance roller unit 46, conveyed by the conveyance roller pair 47, guided to a conveyance roller unit 48 in the image forming apparatus 1000, and abutted against and stopped by a registration roller pair 49 of the conveyance roller unit 48. Thereafter, the registration roller pair 49 is driven in accordance with the above-described timing to feed the sheet to the secondary transfer area.

A sheet can be fed by inserting the sheet onto a bypass sheet tray 51. When a user has inserted a sheet onto the bypass sheet tray 51, a bypass sheet feed roller 50 is rotationally driven to separate one sheet of paper on the bypass sheet tray 51 and draw the sheet into a bypass sheet feed path 53, and the sheet is conveyed by a conveyance roller pair 52 and abuts against the registration roller pair 49 in the same manner.

Various sensors including, for example, a photosensor and the like are mounted on the sheet feeding table 200. Specific examples thereof include a sheet-end sensor that detects the remaining amount or the presence or absence of the sheet stored in the sheet trays 44, a size detection sensor that detects the size or orientation of the sheet, and a tray set detection sensor that detects whether or not each tray is attached to the main body of the image forming apparatus 1000. In addition, a sheet conveyance sensor that detects whether or not a sheet is appropriately conveyed during conveyance of the sheet, whether or not a conveyance jam (paper jam) occurs, and the like is also provided in each sheet tray.

The registration roller pair 49 as a conveyance roller pair is generally grounded and used in many cases, but a bias voltage can also be applied for removing paper dust of the sheet. Specifically, for example, when a conductive rubber roller is used and a bias is applied, the surface is made of conductive NBR rubber having a diameter of 18 [mm] and a thickness of 1 [mm], and the rubber material has an electric resistance of about 10⁹ [Ωcm] in volume resistivity. The surface (image recording surface) of the sheet after passing through the registration roller pair 49 to which the bias is applied is slightly charged to the minus side. Therefore, in a secondary transfer process from the intermediate transfer belt 10 to the sheet, a transfer condition changes as compared with the case where no voltage is applied to the registration roller pair 49. In the present embodiment, a bias is applied to the registration roller pair 49. As a transfer condition, for example, a voltage of about −800 [V] is applied to the secondary transfer roller (the third support roller) 16 supporting the intermediate transfer belt 10. A voltage of about +200 [V] is applied to one of the secondary transfer counter rollers 23 that stretches the secondary transfer belt 24 of the secondary transfer unit 22.

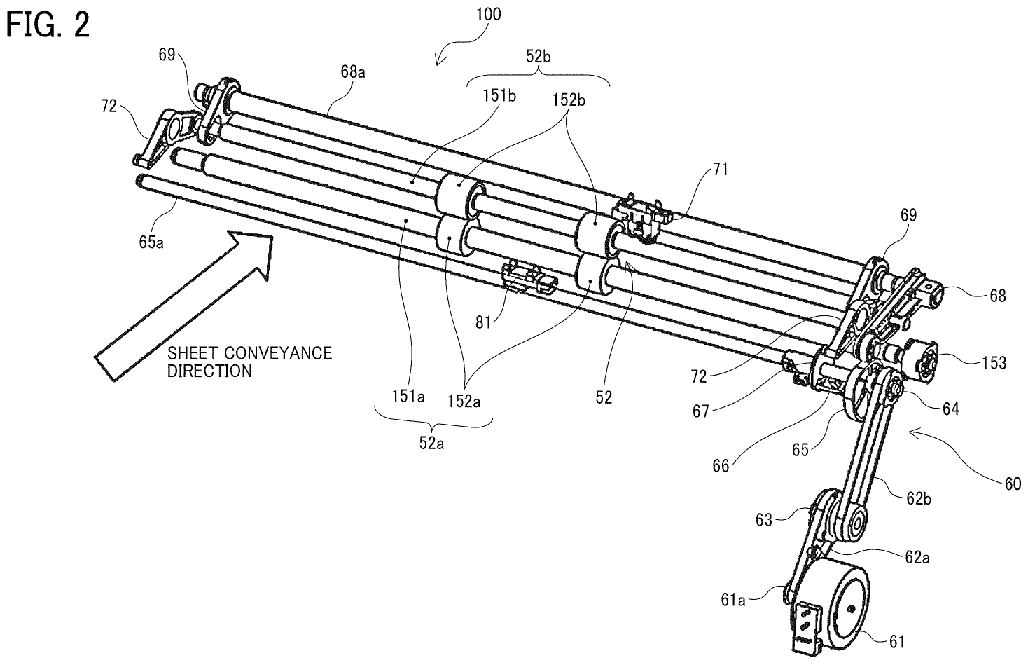

FIG. 2 is a perspective view illustrating a schematic configuration of a sheet thickness detector 100 according to the present embodiment.

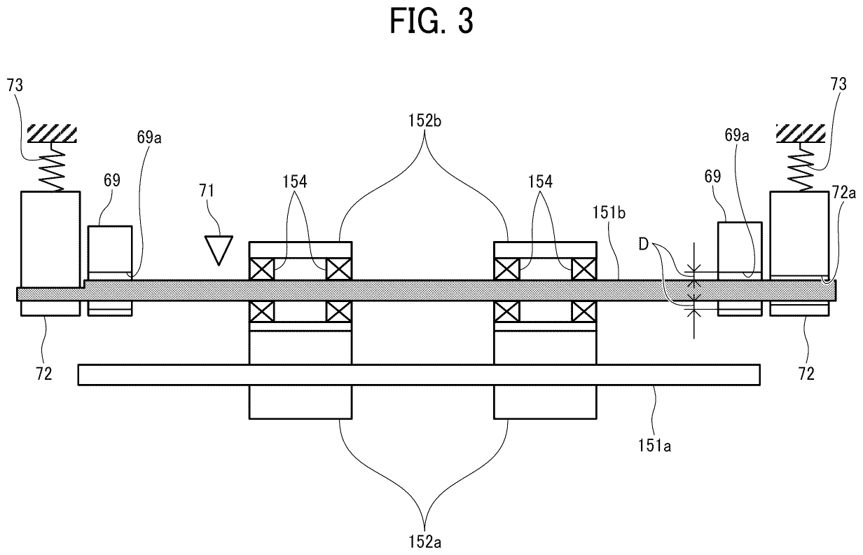

FIG. 3 is a schematic cross-sectional view of the conveyance roller pair 52 included in the sheet thickness detector 100.

In the present embodiment, the conveyance roller pair 52 that conveys the sheet on the bypass sheet tray 51 is the sheet thickness detector 100.

The sheet thickness detector 100 includes the conveyance roller pair 52. The conveyance roller pair 52 includes a drive roller 52a that rotates by driving as a conveyance roller and a detection roller 52b.

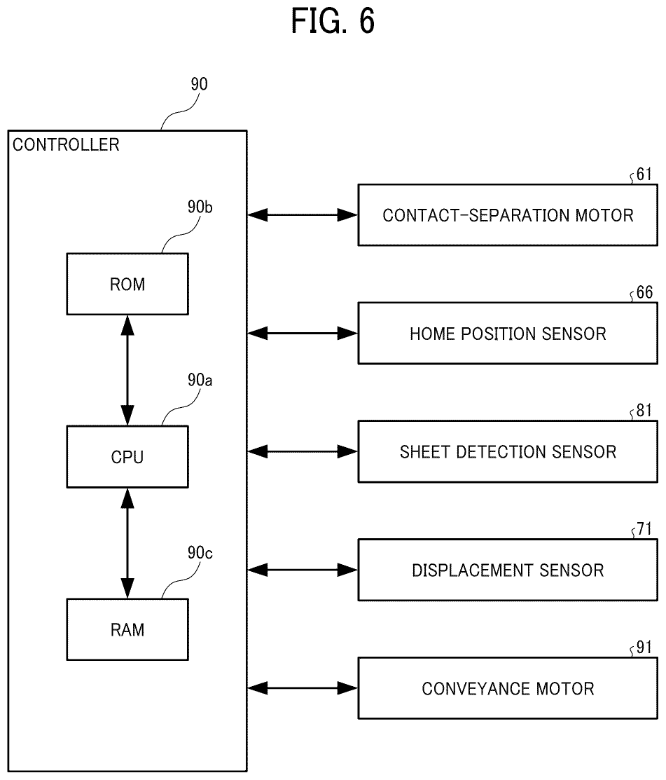

The drive roller 52a includes two drive rollers 152a arranged at a predetermined interval in the axial direction, and a drive shaft 151a. The drive rollers 152a are attached to the drive shaft 151a so as to rotate integrally with the drive shaft 151a. A driven coupling 153 is attached to one end (right end in the drawing) of the drive shaft 151a. The driven coupling 153 is coupled to a drive coupling of a drive device including a conveyance motor 91 (see FIG. 6) provided in the main body of the image forming apparatus 1000. The drive shaft 151a is rotatably supported by a side plate of the main body of the image forming apparatus 1000, and is not movable in the vertical direction (an orthogonal direction orthogonal to both the sheet conveyance direction and the axial direction).

The detection roller 52b includes two driven rollers 152b arranged at a predetermined interval in the axial direction and driven to rotate, and a fixed shaft 151b that is non-rotatably supported. As illustrated in FIG. 3, each of the driven rollers 152b is rotatably supported by the fixed shaft 151b via bearings 154. Both ends (the opposite ends) of the fixed shaft 151b are supported by respective pressure arms 72 as supports.

The other end side (left end side in FIG. 3) of the fixed shaft 151b has the shape of the letter D in cross section, and a shaft support hole 72a of the pressure arm 72 that supports the other end side of the fixed shaft 151b is a hole having the shape of the letter D in cross section. By inserting the portion having the shape of the letter D in cross section on the other end side of the fixed shaft 151b into the shaft support hole 72a having the shape of the letter D in cross section, the pressure arm 72 on the other end side supports the other end side of the fixed shaft 151b so as not to rotate.

On the other hand, the shaft support hole 72a through which the fixed shaft 151b of the pressure arm 72 that supports one end side (right end side in FIG. 3) of the fixed shaft 151b passes is a round hole having substantially the same diameter as the fixed shaft 151b. Further, one end side of the fixed shaft 151b also has a circular shape in cross section, and the pressure arm 72 on one end side supports one end of the fixed shaft 151b so as to be relatively rotatable with respect to the fixed shaft 151b.

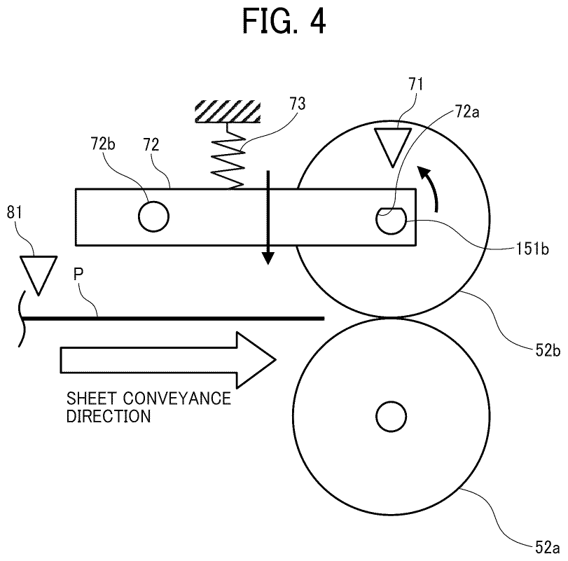

If one end side of the fixed shaft 151b has the shape of the letter D similarly to the other end side, is inserted into the shaft support hole 72a having the shape of the letter D in cross section, and is supported by the pressure arm 72 so as not to be rotatable on the one end side, the following problem may occur. That is, the linear portion of the shape of the letter D on the other end side of the fixed shaft 151b may be inclined with respect to the linear portion of the shape of the letter D on one end side due to a manufacturing error. In addition, the linear portion of the shape of the letter D in cross section of the shaft support hole 72a in the pressure arm 72 on the other end side may be inclined with respect to the linear portion of the shape of the letter D in cross section of the shaft support hole 72a in the pressure arm 72 on one end side due to a manufacturing error. In this case, when the pressure arms 72 are assembled to the fixed shaft 151b, the other pressure arm is inclined with respect to the one pressure arm, and a support shaft 72b (see FIG. 4) of the one pressure arm 72 is shifted in the rotational direction about the fixed shaft 151b with respect to the support shaft 72b of the other pressure arm.

As a result, when the detection roller 52b is assembled to the side plate of the image forming apparatus 1000 via the pair of pressure arms 72, the fixed shaft 151b and the pressure arms 72 are inclined. Due to the inclination of the fixed shaft 151b, there is a possibility that the contact pressures of the driven rollers 152b with the drive rollers 152a are different from each other, or one of the two driven rollers 152b is separated from the drive roller 152a.

In addition, when the pressure arm 72 inclines, the support shaft 72b (see FIG. 4) of the pressure arm 72 may strongly hit a supporting portion, which rotatably supports the support shaft 72b, of the side plate of the image forming apparatus 1000, and smooth rotation of the pressure arm 72 may be hindered. In some cases, the fixed shaft 151b may be twisted or the pressure arm 72 may be deformed.

On the other hand, as in the present embodiment, the shaft support hole 72a of one of the pair of pressure arms 72 is a round hole, and rotatably supports the fixed shaft 151b. As a result, the one pressure arm 72 rotates relative to the fixed shaft 151b, so that the position of the support shaft 72b of the one pressure arm 72 can be aligned with the position of the support shaft 72b of the other pressure arm 72. As a result, the fixed shaft 151b and the pressure arm 72 can be prevented from being inclined and assembled to the image forming apparatus 1000. As a result, a difference in the contact pressure of the driven rollers 152b with respect to the drive rollers 152a can be prevented, and a separation of one of the two driven rollers 152b from the corresponding drive roller 152a can be prevented. In addition, firm contact between the support shaft 72b of the pressure arm 72 and the supporting portion, which rotatably supports the support shaft 72b, of the side plate of the image forming apparatus 1000 can be suppressed, and the pressure arm 72 can be smoothly rotated. In addition, twisting of the fixed shaft 151b and deformation of the pressure arm 72 can be prevented. Further, the detection roller 52b can be easily assembled to the image forming apparatus 1000.

The pair of pressure arms 72 is biased toward the drive roller 52a by compression springs 73 as a pressure unit. The detection roller 52b is pressurized toward the drive roller 52a via the pair of pressure arms 72 by the biasing force of the compression springs 73, and the driven rollers 152b come into contact with the drive rollers 152a at a predetermined contact pressure.

As illustrated in FIG. 4, each of the pressure arms 72 includes the support shaft 72b, and the support shaft 72b is rotatably supported by the side plate of the image forming apparatus 1000. The support shaft 72b is supported by the side plate of the image forming apparatus 1000 via a bearing or the like such that the pressure arm 72 smoothly rotates about the support shaft 72b as a fulcrum.

The support shaft 72b is located upstream from the detection roller 52b in the sheet conveyance direction. In a state where the detection roller 52b is in contact with the drive roller 52a, the axial center of the support shaft 72b and the axial center of the fixed shaft 151b are at the same position in the contact-separation direction (the orthogonal direction orthogonal to both the sheet conveyance direction and the axial direction) of the detection roller 52b with respect to the drive roller 52a.

By placing the axial center of the support shaft 72b at the same position as the axial center of the fixed shaft 151b in the contact-separation direction, the moving direction of the shaft support hole 72a when the pressure arm 72 rotates counterclockwise in the drawing from the state of FIG. 4 can be made substantially the same as the thickness direction of a sheet. This configuration can suppress the effect, on the displacement of the detection roller 52b, of the rotation of the pressure arm 72 when the detection roller 52b is displaced according to the thickness of a sheet, and the thickness of the sheet can be accurately detected.

In the present embodiment, two drive rollers 152a and two driven rollers 152b are provided. In a case where there are three or more drive rollers 152a and three or more driven rollers 152b, one of the plurality of driven rollers 152b may generate a gap with respect to the drive roller 152a due to variations in diameters of the drive rollers 152a and the driven rollers 152b. As a result, as described above, when a sheet enters the conveyance roller pair 52, the detection roller 52b is not displaced by the gap, and the thickness of the sheet may not be accurately detected.

On the other hand, in a case where there are two drive rollers 152a and two driven rollers 152b as in the present embodiment, even if the diameters of the drive rollers 152a and the driven rollers 152b vary, the fixed shaft 151b is inclined, so that all the driven rollers 152b can be brought into contact with the drive rollers 152a. As a result, the detection roller 52b can be displaced by the thickness of a sheet, and the thickness of the sheet can be accurately detected.

As illustrated in FIG. 2, the detection roller 52b can be moved from the contact position with the drive roller 52a to the separation position separated from the drive roller 52a by a separation mechanism 60.

A sheet detection sensor 81 as a sheet detector that detects a sheet is disposed upstream from the conveyance roller pair 52 in the sheet conveyance direction. As will be described below, the separation mechanism 60 brings the detection roller 52b into contact with or separates the detection roller 52b from the drive roller 52a based on a detection result of the sheet detection sensor 81.

The sheet thickness detector 100 includes a displacement sensor 71 as a displacement detection unit that detects displacement of the detection roller 52b. As the displacement sensor 71, a known sensor such as a distance measuring sensor can be used. The displacement sensor 71 is arranged to face the fixed shaft 151b of the detection roller 52b, and detects displacement of the fixed shaft 151b from the contact position, which is the initial position where the detection roller 52b is in contact with the drive roller 52a. The thickness of conveyed sheet is detected based on the detection result of the displacement sensor 71.

Specifically, when the sheet enters the conveyance roller pair 52, the pressure arm 72 rotates counterclockwise in FIG. 4 with the support shaft 72b as a fulcrum, and the detection roller 52b is displaced in a direction away from the drive roller 52a. The displacement sensor 71 detects the displacement of the fixed shaft 151b at this time, thereby detecting the thickness of the sheet.

In the present embodiment, as described above, the pressure arm 72 is supported by the side plate of the image forming apparatus 1000 via a bearing or the like so as to smoothly rotate about the support shaft 72b as a fulcrum. As a result, when a sheet enters the conveyance roller pair 52, the detection roller 52b can be smoothly displaced in the direction away from the drive roller 52a according to the thickness of the sheet, and a highly accurate sheet thickness detection can be performed.

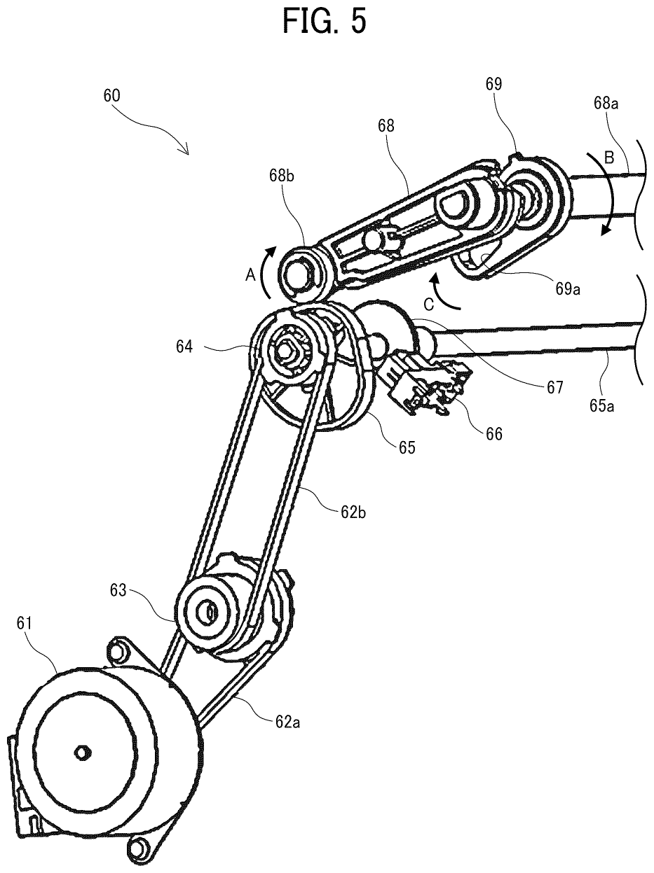

A description is given of the separation mechanism 60 with reference to FIGS. 2 and 5.

FIG. 5 is a schematic perspective view of the separation mechanism 60.

The separation mechanism 60 includes a contact-separation motor 61. The contact-separation motor 61 includes a motor shaft to which a motor pulley 61a is attached, and a first timing belt 62a is stretched between the motor pulley and a two-stage pulley 63. In addition, a second timing belt 62b is stretched between the two-stage pulley 63 and a cam pulley 64 attached to one end (right end portion in FIG. 2) of a camshaft 65a.

On one end side of the camshaft 65a, a cam 65 and a detection filler 67 detected by a home position sensor 66 are attached so as to be rotatable integrally with the camshaft 65a. The camshaft 65a is rotatably supported by the side plate of the image forming apparatus 1000. The cam 65 is in contact with a cam contact part 68b of a cam follower 68 located above. The cam contact part 68b is provided at one end of the cam follower 68. The other end of the cam follower 68 is attached to one end of a cam follower shaft 68a so as to be rotatable integrally with the cam follower shaft 68a. The cam follower shaft 68a is rotatably supported by the side plate of the main body of the image forming apparatus 1000.

On each end side of the cam follower shaft 68a, one end of a contact-separation arm 69 is attached so as to be rotatable integrally with the cam follower shaft 68a.

The other end of the contact-separation arm 69 is provided with a through hole 69a through which the fixed shaft 151b passes is provided.

In the present embodiment, as will be described below, when the detection roller 52b is positioned at the contact position where the detection roller 52b is in contact with the drive roller 52a, the fixed shaft 151b is not in contact with the through hole 69a.

A description is given of the contact-separation operation of the detection roller 52b by the separation mechanism 60.

When the detection roller 52b is positioned at a home position, which is the initial position and the contact position where the detection roller 52b is in contact with the drive roller 52a, the home position sensor 66 does not detect the detection filler 67. When the detection roller 52b is positioned at the home position, the bottom dead center of the cam 65 is in contact with the cam contact part 68b of the cam follower 68. Specifically, due to the weight of the cam follower 68 and the weight of the contact-separation arm 69, a force to rotate the cam follower 68 in a direction opposite to the direction of arrow A in FIG. 5 acts, and the cam contact part 68b contacts the cam 65 by this force.

The contact-separation motor 61 is a stepping motor, and performs a separation operation by managing a rotation angle starting from the home position based on the number of pulses. As long as the rotation angle can be managed, the contact-separation motor 61 may not be a stepping motor, and for example, a DC motor and an encoder or the like may be used in combination, or a solenoid may be used as a drive source.

When the contact-separation motor 61 is driven, the driving force of the contact-separation motor 61 is transmitted to the cam pulley 64 via the first timing belt 62a and the second timing belt 62b, and the camshaft 65a is rotationally driven. When the camshaft 65a rotates, the detection filler 67 and the cam 65 attached to the camshaft 65a are rotationally driven.

When the detection filler 67 rotates, the detection filler 67 is detected by the home position sensor 66. When the cam 65 rotates, the cam contact part 68b of the cam follower 68 is lifted. When the cam contact part 68b is lifted, the cam follower 68 rotates in the direction of arrow A in FIG. 5 about the cam follower shaft 68a as a fulcrum. At this time, since the cam follower 68 is attached to the cam follower shaft 68a so as to be rotatable integrally with the cam follower shaft 68a, the cam follower shaft 68a rotates in the direction of arrow B in FIG. 5 together with the cam follower 68.

When the cam follower shaft 68a rotates in the direction of arrow B in FIG. 5, the contact-separation arm 69 attached to the cam follower shaft 68a so as to be rotatable integrally with the cam follower shaft 68a rotates in the direction of arrow C in FIG. 5. The inner peripheral surface of the through hole 69a of the contact-separation arm 69 contacts the fixed shaft 151b by the rotation of the contact-separation arm 69 in the direction of arrow C, and the detection roller 52b is moved in the direction away from the drive roller 52a against the pressurizing force of the pressure arm 72.

When the top dead center of the cam 65 reaches the contact position with the cam contact part 68b, the detection roller 52b reaches the separation position, which stops driving of the contact-separation motor 61.

When the detection roller 52b is moved from the separation position to the contact position, the contact-separation motor 61 is reversely rotated. When the detection roller 52b is positioned at the separation position, the pressurizing force of the pressure arm 72 is applied to the contact-separation arm 69 via the detection roller 52b. The pressurizing force of the pressure arm 72 is a force for rotating the cam follower 68 in the direction opposite to the direction of arrow A in FIG. 5, and the cam contact part 68b descends following the outer peripheral surface of the cam 65. As a result, the contact-separation arm 69 rotates in a direction opposite to the direction of arrow C in FIG. 5, and the detection roller 52b approaches the drive roller 52a by the pressurizing force of the pressure arm 72.

Even after the detection roller 52b contacts the drive roller 52a, the contact-separation motor 61 continues to be driven, and the contact-separation arm 69 rotates in the direction opposite to the direction of arrow C in FIG. 5. Then, when the fixed shaft 151b of the detection roller 52b is separated from the through hole 69a of the contact-separation arm 69 and the separation mechanism 60 and the detection roller 52b are in the non-contact state, the bottom dead center of the cam 65 reaches the contact position with the cam contact part 68b. In addition, the contact-separation motor 61 starts to decelerate from the time point when the bottom dead center of the cam 65 reaches the contact position with the cam contact part 68b and the home position sensor 66 no longer detects the detection filler 67. Then, the driving of the contact-separation motor 61 is stopped at a certain angle from the time point when the home position sensor 66 no longer detects the detection filler 67, and this position is set as the home position.

FIG. 6 is a block diagram of the sheet thickness detector 100 according to the present embodiment.

The controller 90 as a control unit controls the entire image forming apparatus 1000, and includes a central processing unit (CPU) 90a as a calculation unit, a random access memory (RAM) 90c and a read-only memory (ROM) 90b as information storages.

The controller 90 is electrically connected to the contact-separation motor 61 of the separation mechanism 60, the home position sensor 66 of the separation mechanism 60, the sheet detection sensor 81, the displacement sensor 71, the conveyance motor 91 that rotationally drives the drive roller 52a, and the like, and the controller 90 controls each operation.

Specifically, as will be described below, the controller 90 controls driving of the contact-separation motor 61 based on a detection result of the sheet detection sensor 81 and a detection result of the home position sensor 66.

The displacement of the detection roller 52b (fixed shaft 151b) is detected by the displacement sensor 71, for example, as follows. When the sheet detection sensor 81 detects the leading end of a sheet, the controller 90 starts time measurement. Then, when the measurement time reaches a timing when a predetermined time has elapsed and the sheet enters the conveyance roller pair 52 and has been conveyed by a predetermined amount, the displacement sensor 71 detects displacement of the detection roller 52b (fixed shaft 151b) in the direction away from the drive roller 52a by the displacement sensor 71.

For example, when the displacement sensor 71 is a distance measuring sensor, the displacement (displacement amount) of the detection roller 52b (fixed shaft 151b) from the contact position is detected as follows. That is, the distance from the detection roller 52b (fixed shaft 151b) at the contact position is measured by the distance measuring sensor, and the measurement value (distance) at this time is stored in the RAM 90c of the controller 90 as a reference distance. The displacement (displacement amount) of the detection roller 52b (fixed shaft 151b) is detected based on the distance from the detection roller 52b (fixed shaft 151b) measured when the sheet enters and the stored reference distance.

It is preferable that the displacement is detected by the displacement sensor 71 a plurality of times, and the plurality of detected displacements (displacement amounts) is averaged over a time corresponding to a desired number of rotations of the driven roller 152b. As a result, the influence of the eccentricity of the driven roller 152b, the eccentricity of the drive roller 152a, and the like can be excluded, and a highly accurate sheet thickness detection can be performed.

The controller 90 grasps the thickness of the sheet based on the detected displacement (displacement amount). Then, according to the grasped thickness of the sheet, for example, a sheet material conveyance operation such as a sheet conveyance speed and a nip pressure of a roller pair for conveyance is changed, or an image forming operation such as a secondary transfer condition (secondary transfer bias value) and a fixing temperature is changed. By detecting the thickness of the sheet at a portion upstream from the registration roller pair 49 in the sheet conveyance direction, the secondary transfer condition (secondary transfer bias value) can be set according to the thickness of the sheet.

In the present embodiment, when the sheet is conveyed to a secondary transfer nip by the registration roller pair 49, the detection roller 52b is separated from the drive roller 52a, and the sheet is conveyed to the secondary transfer nip by the registration roller pair 49 alone. This is because the conveyance roller pair 52 may be inclined in the sheet conveyance direction with respect to the registration roller pair 49 due to a component tolerance, an installation state of a peripheral device, or the like. In this case, when the sheet is conveyed toward the secondary transfer nip by the conveyance roller pair 52 and the registration roller pair 49, the sheet is skewed due to the influence of the conveyance by the conveyance roller pair 52, and the sheet may enter the secondary transfer nip in a skewed state. As a result, a toner image is not secondarily transferred to a desired position on the sheet, and the toner image may be inclined with respect to the sheet. In addition, when the sheet is conveyed in the skew state, the sheet is caught on the downstream side of the registration roller pair 49 in the sheet conveyance direction, and a paper jam may occur.

Therefore, in the present embodiment, after the conveyance of the sheet by the registration roller pair 49 is started, the detection roller 52b is promptly separated from the drive roller 52a, and when the trailing end of the sheet has passed through the conveyance roller pair 52, the detection roller 52b is brought into contact with the drive roller 52a.

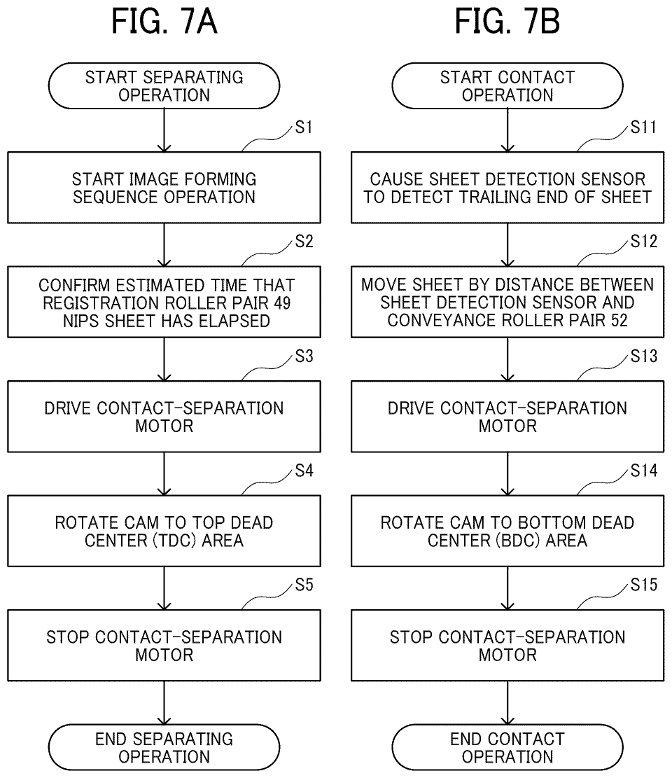

FIG. 7A is a control flowchart of a separation operation of separating the detection roller 52b from the drive roller 52a.

FIG. 7B is a control flowchart of a contact operation of bringing the detection roller 52b into contact with the drive roller 52a.

As illustrated in FIG. 7A, driving of the contact-separation motor 61 is started at a timing when a certain period of time elapses from an image formation sequence operation timing of each color and the leading end of the sheet fed from the bypass sheet tray 51 is nipped by the registration roller pair 49 (steps S1 to S3).

When the driving of the contact-separation motor 61 is started, as described above, the cam 65 rotates, and the cam contact part 68b of the cam follower 68 is lifted. When the cam contact part 68b is lifted, the cam follower 68 rotates about the cam follower shaft 68a as a fulcrum, the contact-separation arm 69 rotates, and the detection roller 52b moves in the direction away from the drive roller 52a.

Then, when the top dead center of the cam 65 reaches the contact position with the cam contact part 68b (step S4) and the detection roller 52b reaches the separation position (when the contact-separation motor 61 rotates by a certain angle), the driving of the contact-separation motor 61 is stopped (step S5). As a result, the separation operation is completed immediately after a conveyance of a sheet is started by the registration roller pair 49.

As illustrated in FIG. 7B, the conveyance of the sheet is started by the registration roller pair 49, and when the trailing end of the sheet is detected by the sheet detection sensor 81 (step S11), the controller 90 starts time measurement. When the measurement time reaches a specified time, the sheet moves the distance from the sheet detection sensor 81 to the conveyance roller pair 52 (step S12), and the trailing end of the sheet has passed through the conveyance roller pair 52, the reverse rotation drive of the contact-separation motor 61 is started (step S13).

Then, when the bottom dead center of the cam 65 reaches the contact position with the cam contact part 68b (step S14) and the detection roller 52b reaches the contact position with the drive roller 52a (when the home position sensor 66 does not detect the detection filler 67 and detects the home position), the driving of the contact-separation motor 61 is stopped (step S15). As a result, the thickness of the sheet fed from the bypass sheet tray 51 can be detected in the subsequent step.

A description is now given of details of the present embodiment.

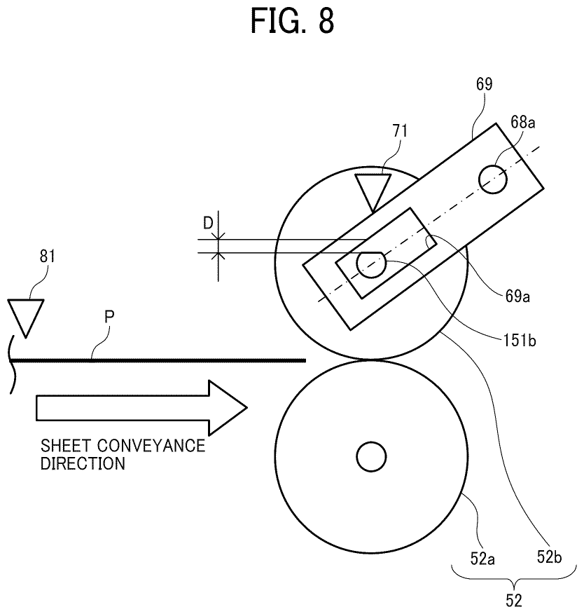

FIG. 8 is a schematic view illustrating a relationship between the contact-separation arm 69 and the fixed shaft 151b.

As illustrated in FIG. 8, the through hole 69a through which the fixed shaft 151b provided in the contact-separation arm 69 passes has a rectangular shape, and the lengths of the long side and the short side of the through hole 69a are larger than the diameter of the fixed shaft 151b. Then, as illustrated in FIG. 8, when the detection roller 52b is positioned at the contact position which is the initial position where the detection roller 52b is in contact with the drive roller 52a, a gap is formed between the fixed shaft 151b and the through hole 69a. At the contact position, the fixed shaft 151b is not in contact with the contact-separation arm 69, and the separation mechanism 60 is physically separated from the detection roller 52b (see also FIG. 3). In the present embodiment, the cam contact part 68b of the cam follower 68 contacts the bottom dead center of the cam 65 by the weight of the cam follower 68 or the like, so that the posture of the contact-separation arm 69 is in the state of FIG. 8, and the fixed shaft 151b is not in contact with the contact-separation arm 69.

The minimum gap D from the fixed shaft 151b to the upper portion of the through hole 69a is equal to or larger than the maximum thickness of a sheet that can be conveyed by the image forming apparatus 1000 of the present embodiment. As a result, the fixed shaft 151b and the contact-separation arm 69 do not come into contact with each other even when the image forming apparatus 1000 detects the thickness of the sheet having the maximum thickness that can be conveyed.

In the typical configuration in which the length of the short side of the through hole 69a of the contact-separation arm 69 is the diameter of the fixed shaft 151b and the fixed shaft 151b is constantly in contact with the through hole 69a, the following problem may occur. That is, there is a problem in that the fixed shaft 151b bends, and the thickness of a sheet cannot be accurately detected.

As illustrated in FIG. 3, both ends (the opposite ends) of the fixed shaft 151b are pressurized toward the drive roller 52a by the pressurizing force of the pressure arms 72. On the other hand, the rotation of each contact-separation arm 69 in the counterclockwise direction in FIG. 8 is restricted by the contact between the cam contact part 68b of the cam follower 68 and the cam 65, and in the case of the typical configuration, the pressurizing force of each pressure arm 72 applied to the fixed shaft 151b is received by the corresponding cam 65. As a result, when the detection roller 52b is positioned at the contact position where the detection roller 52b is in contact with the drive roller 52a, the fixed shaft 151b is bent such that each end is positioned closer to the drive roller 52a than the center by the pressurizing force of the pressure arm 72 with the contact-separation arm 69 as a fulcrum.

On the other hand, the clockwise rotation of the contact-separation arm 69 in FIG. 8 is rotatable without being restricted by the cam 65. Therefore, in the typical configuration, when a sheet enters the conveyance roller pair 52 and the detection roller 52b moves in the direction away from the drive roller 52a according to the thickness of the sheet, the contact-separation arm 69 rotates integrally with the cam follower shaft 68a and the cam follower 68 about the cam follower shaft 68a as a fulcrum. As a result, the cam contact part 68b of the cam follower 68 is separated from the cam 65. When the cam contact part 68b is separated from the cam 65, the cam 65 does not receive the pressurizing force of the pressure arm 72, and the reaction force of the pressurizing force of the pressure arm 72 from the contact-separation arm 69 is not applied to the fixed shaft 151b. As a result, the bend of the fixed shaft 151b decreases. As the bend of the fixed shaft 151b decreases, the displacement amount of the fixed shaft 151b becomes smaller than the displacement amount of the driven rollers 152b, and the displacement amount of the fixed shaft 151b does not correspond to the displacement amount corresponding to the thickness of a sheet. Therefore, there is a possibility that the typical configuration cannot perform a highly accurate sheet thickness detection.

In the typical configuration, when the posture of the contact-separation arm 69 when the detection roller 52b is positioned at the contact position is deviated from the target posture due to a manufacturing error, an assembling error, or the like, the fixed shaft 151b receives a force from the contact-separation arm 69. As a result, the fixed shaft 151b may be bent.

Further, in the typical configuration, at the time of detecting the thickness of the sheet (at the time of detecting the displacement of the fixed shaft 151b), vibration is propagated to the cam follower shaft 68a via the side plate of the image forming apparatus 1000, and movable components including the contact-separation arm 69, the cam follower shaft 68a, and the cam follower 68 vibrate. Due to this vibration, the fixed shaft 151b slightly vibrates in the contact-separation direction with respect to the drive roller 52a, and it is likely that a highly accurate sheet thickness detection (displacement detection of the fixed shaft 151b) is performed.

On the other hand, in the present embodiment, as illustrated in FIG. 8, when the detection roller 52b is located at the contact position and when the thickness of a sheet is detected, the fixed shaft 151b and the contact-separation arm 69 are not in contact with each other. As a result, when the detection roller 52b is positioned at the contact position and when the thickness of the sheet is detected, the separation mechanism 60 can be physically separated from the detection roller 52b.

Therefore, when the detection roller 52b is located at the contact position, the force of the separation mechanism 60 does not act on the fixed shaft 151b, and the bend of the fixed shaft 151b is suppressed. In addition, the vibration of the movable components including the contact-separation arm 69 of the separation mechanism 60, the cam follower shaft 68a, and the cam follower 68 does not propagate to the fixed shaft 151b, and the thickness of the sheet can be detected with high accuracy.

In the present embodiment, the bypass sheet tray 51 is removed, and a sheet bank that can load and feed a large amount of sheets can be optionally attached to the main body of the image forming apparatus 1000. When the sheet bank is attached, the conveyance unit including the bypass sheet feed roller 50, the conveyance roller pair 52, and the bypass sheet feed path 53 is removed from the image forming apparatus 1000, and replaced with a conveyance unit including an inlet roller pair and a conveyance roller pair.

By providing the sheet thickness detector of the present disclosure in the sheet bank, the thickness of a sheet fed from the sheet bank can be accurately detected, and a secondary transfer condition and the like can be changed based on the detected thickness. When the sheet thickness detector of the present disclosure is not provided in the sheet bank, a coupling unit provided with the sheet thickness detector of the present disclosure may be coupled between the image forming apparatus 1000 and the sheet bank.

In addition, among the plurality of conveyance roller pairs 47 that conveys the sheet fed from the sheet trays 44 illustrated in FIG. 1, the conveyance roller pair 47 disposed on the most downstream side in the sheet conveyance direction may be used as a sheet thickness detector to detect the thickness of the sheet fed from the sheet trays 44.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The configurations according to the above-described embodiments are examples, and embodiments of the present disclosure are not limited to the above. For example, the following aspects can achieve effects described below.

### Aspect 1

In Aspect 1, a sheet thickness detector such as a sheet thickness detector 100 includes: a conveyance roller pair 52 including: a conveyance roller such as a drive roller 52a that conveys a sheet such as paper; and a detection roller 52b supported to be contactable with and separable from the conveyance roller in an orthogonal direction orthogonal to both a sheet conveyance direction and a rotation shaft direction of the conveyance roller; a pressure unit such as a compression spring 73 that pressurizes the detection roller 52b toward the conveyance roller; a separation mechanism 60 that separates the detection roller 52b from the conveyance roller; and a displacement detection unit such as a displacement sensor 71 that detects displacement of the detection roller 52b in the orthogonal direction from an initial position such as a contact position in a state where the detection roller 52b is in contact with the conveyance roller, the sheet thickness detector detecting the thickness of the sheet based on the displacement of the detection roller 52b detected by the displacement detection unit when the sheet is nipped and conveyed by the conveyance roller pair 52, in which when the thickness of the sheet is detected, the separation mechanism is separated from the detection roller.

In the sheet thickness detector in the art, when the thickness of a sheet is detected, vibration of a movable component such as an arm member of a separation mechanism may be propagated to a detection roller via a pressure unit such as a torsion spring to vibrate the detection roller. When the vibration of the movable component of the separation mechanism propagates to the detection roller and the detection roller vibrates, a displacement detection unit cannot accurately detect the displacement of the detection roller due to the vibration of the detection roller, and the thickness of the sheet may not be accurately detected.

On the other hand, in Aspect 1, since the separation mechanism is separated from the detection roller when the thickness of the sheet is detected, vibration of the separation mechanism can be prevented from propagating to the detection roller, displacement of the detection roller can be accurately detected, and the thickness of the sheet can be accurately detected.

In addition, by providing, separately from the separation mechanism, the pressure unit such as the compression spring 73 that pressurizes the detection roller toward the conveyance roller, the detection roller can be pressurized toward the conveyance roller even if the separation mechanism is separated from the detection roller when the thickness of the sheet is detected.

### Aspect 2

In Aspect 2, in the sheet thickness detector according to Aspect 1, the separation mechanism 60 moves the detection roller 52b to a separation position separated from the conveyance roller such as the drive roller 52a at a timing when the conveyance roller pair on the downstream side in the sheet conveyance direction of the conveyance roller pair 52 such as the registration roller pair 49 nips the leading end of the sheet, and moves the detection roller 52b from the separation position to the initial position such as the contact position after the trailing end of the sheet passes through the conveyance roller pair 52.

According to this configuration, conveyance of the sheet by the conveyance roller pair 52 and a conveyance roller pair on the downstream side such as the registration roller pair 49 can be suppressed. As a result, the sheet can be prevented from being skewed by the sheet conveying force of the conveyance roller pair 52.

In addition, after the trailing end of the sheet passes through the conveyance roller pair 52, the detection roller 52b is moved from the separation position to the initial position such as the contact position, so that the detection roller 52b can be positioned at the initial position before the subsequent sheet enters the conveyance roller pair 52, and the subsequent sheet thickness detection can be performed.

### Aspect 3

In Aspect 3, the sheet thickness detector according to Aspect 2 further includes a sheet detector such as a sheet detection sensor 81 that detects a sheet at a portion upstream from the conveyance roller pair 52 in the sheet conveyance direction, in which the separation mechanism 60 moves the detection roller 52b from the separation position to the initial position such as the contact position based on a sheet detection result of the sheet detector.

According to this configuration, as described in the embodiment above, the sheet detector such as the sheet detection sensor 81 detects the trailing end of the sheet, and the detection roller 52b can be moved from the separation position to the initial position such as the contact position after a lapse of a predetermined time. As a result, the detection roller 52b can be reliably and quickly moved to the initial position after the trailing end of the sheet has passed through the conveyance roller pair.

### Aspect 4

In Aspect 4, in the sheet thickness detector according to any one of Aspects 1 to 3, the detection roller 52b includes: a fixed shaft 151b that is non-rotatably supported; and a roller part such as a driven roller 152b that is rotatably supported with respect to the fixed shaft.

According to this configuration, as described in the embodiment above, in a case where the detection roller 52b includes the rotation shaft and the roller part that rotates integrally with the rotation shaft, when the sheet is nipped and conveyed by the detection roller 52b and the conveyance roller, the eccentricity of the rotation shaft and the eccentricity of the roller part affect the displacement of the detection roller 52b in a direction away from the conveyance roller such as the drive roller 52a, and the thickness of the sheet such as paper may not be accurately detected.

On the other hand, in Aspect 4, by setting, as the fixed shaft, the shaft supporting the roller part of the detection roller 52b, the eccentricity of the roller part alone affects the displacement of the detection roller 52b, and the thickness of the sheet can be accurately detected as compared with the case where the eccentricity of both the roller part and the shaft supporting the roller part affects the displacement of the detection roller 52b.

### Aspect 5

In Aspect 5, in the sheet thickness detector according to Aspect 4, each end of the fixed shaft 151b is supported by a supporting member such as the pressure arm 72, a supporting member supporting one end of the fixed shaft 151b non-rotatably supports the fixed shaft 151b, and a supporting member supporting the other end of the fixed shaft 151b rotatably supports the fixed shaft 151b.

According to this configuration, as described in the embodiment, the fixed shaft 151b is non-rotatably supported, and each supporting member can be attached to the side plate or the like of the image forming apparatus 1000 without inclining the fixed shaft 151b.

### Aspect 6

In Aspect 6, in the sheet thickness detector of any one of Aspects 1 to 5, the separation mechanism 60 comes into contact with each end side of a shaft of the detection roller 52b to bring the detection roller 52b into contact with or separate the detection roller 52b from the conveyance roller, and the separation mechanism 60 is not in contact with the detection roller 52b positioned at the initial position such as the contact position except during a separation operation of separating the detection roller 52b from the conveyance roller such as the drive roller 52a.

According to this configuration, as described in the embodiment above, the separation mechanism 60 can be prevented from pushing both end sides (the opposite end sides) of the shaft such as the fixed shaft 151b of the detection roller positioned at the initial position such as the contact position due to a manufacturing error or the like, and bending the shaft of the detection roller. As a result, when the detection roller is displaced in the direction away from the conveyance roller at the time of detecting the thickness of the sheet such as paper, the pressing force can be prevented from the separation mechanism 60 from changing and the bend of the shaft of the detection roller from changing. As a result, the displacement of the detection roller corresponds to the thickness of the sheet, and the thickness of the sheet can be accurately detected.

### Aspect 7

In Aspect 7, a sheet conveyor includes a sheet thickness detection unit that detects the thickness of a sheet such as paper, in which the sheet thickness detector according to any one of Aspects 1 to 6 is used as the sheet thickness detection unit.

According to this configuration, as described in the embodiment above, the thickness of a sheet being conveyed can be accurately detected.

### Aspect 8

In Aspect 8, an image forming apparatus 1000 includes a sheet conveyor, in which the sheet conveyor according to Aspect 7 is used as the sheet conveyor.

According to this configuration, the thickness of the sheet being conveyed can be accurately detected.

### Aspect 9

In Aspect 9, a sheet thickness detector includes a conveyance roller pair, a pressing member, a separation mechanism, and a displacement detector. The conveyance roller pair includes a conveyance roller and a detection roller. The conveyance roller is rotatable about a drive shaft to convey a sheet in a sheet conveyance direction. The detection roller is separately contactable with the conveyance roller to nip the sheet between the conveyance roller and the detection roller at an initial position. The pressing member presses the detection roller to the conveyance roller in a contact direction orthogonal to the sheet conveyance direction and an axial direction of the drive shaft. The separation mechanism separates the detection roller from the conveyance roller in a separation direction opposite to the contact direction. The displacement detector detects a displacement of the detection roller in the separation direction from the initial position to detect a thickness of the sheet in response to a nip of the sheet by the conveyance roller pair. The separation mechanism is decoupled from the detection roller in response to a detection of the thickness of the sheet.

### Aspect 10

In Aspect 10, the sheet thickness detector according to Aspect 9 further includes another conveyance roller pair downstream from the conveyance roller pair in the sheet conveyance direction to convey the sheet in the conveyance direction. The separation mechanism moves the detection roller to a separation position at which the detection roller is separated from the conveyance roller when said another conveyance roller pair nips a leading end of the sheet, and moves the detection roller from the separation position to the initial position after a trailing end of the sheet passes through the conveyance roller pair.

### Aspect 11

In Aspect 11, the sheet thickness detector according to Aspect 10 further includes a sheet detector to detect the sheet at a portion upstream from the conveyance roller pair in the sheet conveyance direction. The separation mechanism moves the detection roller from the separation position to the initial position in response to a detection of the sheet by the sheet detector.

### Aspect 12

In Aspect 12, in the sheet thickness detector according to any one of Aspects 9 to 11, the detection roller includes a fixed shaft non-rotatably supported, and a roller part supported to the fixed shaft and rotatably driven by the conveyance roller.

### Aspect 13

In Aspect 13, the sheet thickness detector according to Aspect 12 further includes supports supporting opposite ends of the fixed shaft. Each of the supports includes a first support to non-rotatably support a first end of the opposite ends of the fixed shaft, and a second support to rotatably support a second end of the opposite ends of the fixed shaft.

### Aspect 14

In Aspect 14, in the sheet thickness detector according to Aspect 12, the supports have arms each including the first support at one end and the second support at a position closer to another end than the first support. The second support is upstream of the first support in each of the arms in the conveyance direction.

### Aspect 15

In Aspect 15, in the sheet thickness detector according to Aspect 14, the pressing member presses each of the arms at a position between the first support and the second support.

### Aspect 16

In Aspect 16, in the sheet thickness detector according to Aspect 14 further includes other supports supporting the fixed shaft at positions inside the supports in the axial direction. The other supports include arms each having a through hole through which the fixed shaft. The through hole has lengths of the long side and the short side of the through hole larger than a diameter of the fixed shaft. A gap is formed between the fixed shaft and the through hole to decouple the separation mechanism from the detection roller when the detection roller is positioned at the initial position.

### Aspect 17

In Aspect 17, in the sheet thickness detector of any one of Aspects 9 to 16, the separation mechanism is coupled with opposite ends of a shaft of the detection roller to cause the detection roller to be separated from the conveyance roller in a separation operation. The separation mechanism is decoupled from opposite ends of the shaft of the detection roller at the initial position during a time other than the separation operation.

### Aspect 18

In Aspect 18, a sheet conveyor includes the sheet thickness detector according to any one of Aspects 9 to 17 to detect the thickness of the sheet.

### Aspect 19

In Aspect 19, an image forming apparatus includes the sheet conveyor according to any one of Aspects 9 to 18.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet thickness detector comprising:
a conveyance roller pair including:
a conveyance roller rotatable about a drive shaft to convey a sheet in a sheet conveyance direction; and
a detection roller separately contactable with the conveyance roller to nip the sheet between the conveyance roller and the detection roller at an initial position;
a pressing member to press the detection roller to the conveyance roller in a contact direction orthogonal to the sheet conveyance direction and an axial direction of the drive shaft;
a separation mechanism to separate the detection roller from the conveyance roller in a separation direction opposite to the contact direction; and
a displacement detector to detect a displacement of the detection roller in the separation direction from the initial position to detect a thickness of the sheet in response to a nip of the sheet by the conveyance roller pair,
wherein the separation mechanism is decoupled from the detection roller in response to a detection of the thickness of the sheet.

2. The sheet thickness detector according to claim 1, further comprising another conveyance roller pair downstream from the conveyance roller pair in the sheet conveyance direction to convey the sheet in the conveyance direction,
wherein the separation mechanism:
moves the detection roller to a separation position at which the detection roller is separated from the conveyance roller when said another conveyance roller pair nips a leading end of the sheet; and
moves the detection roller from the separation position to the initial position after a trailing end of the sheet passes through the conveyance roller pair.

3. The sheet thickness detector according to claim 2, further comprising a sheet detector to detect the sheet at a portion upstream from the conveyance roller pair in the sheet conveyance direction,
wherein the separation mechanism moves the detection roller from the separation position to the initial position in response to a detection of the sheet by the sheet detector.

4. The sheet thickness detector according to claim 1,
wherein the detection roller includes:
a fixed shaft non-rotatably supported; and
a roller part supported to the fixed shaft and rotatably driven by the conveyance roller.

5. The sheet thickness detector according to claim 4, further comprising supports supporting opposite ends of the fixed shaft,
wherein each of the supports includes:
a first support to non-rotatably support a first end of the opposite ends of the fixed shaft; and
a second support to rotatably support a second end of the opposite ends of the fixed shaft.

6. The sheet thickness detector according to claim 5,
wherein the supports have arms each including the first support at one end and the second support at a position closer to another end than the first support, and
the second support is upstream of the first support in each of the arms in the conveyance direction.

7. The sheet thickness detector according to claim 6,
wherein the pressing member presses each of the arms at a position between the first support and the second support.

8. The sheet thickness detector according to claim 6, further comprising other supports supporting the fixed shaft at positions inside the supports in the axial direction,
wherein the other supports include arms each having a through hole through which the fixed shaft,
the through hole has lengths of a long side and a short side of the through hole larger than a diameter of the fixed shaft, and
a gap is formed between the fixed shaft and the through hole to decouple the separation mechanism from the detection roller when the detection roller is positioned at the initial position.

9. The sheet thickness detector according to claim 1,
wherein the separation mechanism is coupled with opposite ends of a shaft of the detection roller to cause the detection roller to be separated from the conveyance roller in a separation operation, and
the separation mechanism is decoupled from opposite ends of the shaft of the detection roller at the initial position during a time other than the separation operation.

10. A sheet conveyor comprising the sheet thickness detector according to claim 1 to detect the thickness of the sheet.

11. An image forming apparatus comprising the sheet conveyor according to claim 10.
